(19) United States
(12) Patent Application Publication
(10) Pub. No.: US 2014/0301731 A1
(43) Pub. Date: Oct. 9, 2014

(54) ROTATION MECHANISM FOR CAMERA

(71) Applicant: Ingrasys Technology Inc., Taoyuan (TW)

(72) Inventor: SHU-YUN HUANG, Taoyuan (TW)

(73) Assignee: Ingrasys Technology Inc., Taoyuan (TW)

(21) Appl. No.: 14/242,977

(22) Filed: Apr. 2, 2014

(30) Foreign Application Priority Data
Apr. 3, 2013 (TW) 102112042

(51) Int. Cl. G03B 17/12

(52) U.S. Cl. CPC G03B 17/12
USPC 396/529

(57) ABSTRACT

A rotation mechanism includes a first bracket, a second bracket, a connection member, a pin, and a screw. The first bracket includes a base and two opposite pivot arms. The second bracket includes two opposite pivot plates. The connection member includes a main body, a stop tab extending from a first end of the main body, and a fastening portion formed on a second end of the main body. The main body axially defines a through hole. The fastening portion defines a plurality of slits communicating with the through hole. The main body extends through one of the pivot plates and the corresponding pivot arm. The pin extends into the through hole to make the fastening portion expand blocking an inner side surface of the corresponding pivot arm. The screw extends through the other pivot plate and engages in the other pivot arm.

### FIELD

The present disclosure relates to a rotation mechanism for a camera.

### BACKGROUND

A lens of a camera is generally mounted to a rotation mechanism. The rotation mechanism includes a first bracket and a second bracket. The lens is mounted to the first bracket, and the first bracket is rotatably connected to the second bracket. After the first bracket is rotated a certain angle relative to the second bracket, C-shaped clips are used to position the first bracket to the second bracket. When the rotation mechanism may be detached and assembled many times, as such the clips may become deformed, so that the first bracket cannot be fastened to the second bracket firmly.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a rotation mechanism together with a lens module of a camera, wherein the rotation mechanism comprises a connection member.

FIG. 2 is a cross-sectional view of the connection member of FIG. 1.

FIG. 3 is an assembled, isometric view of the rotation mechanism together with a lens module of a camera of FIG. 1.

FIG. 4 is an assembled, isometric view of the rotation mechanism of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

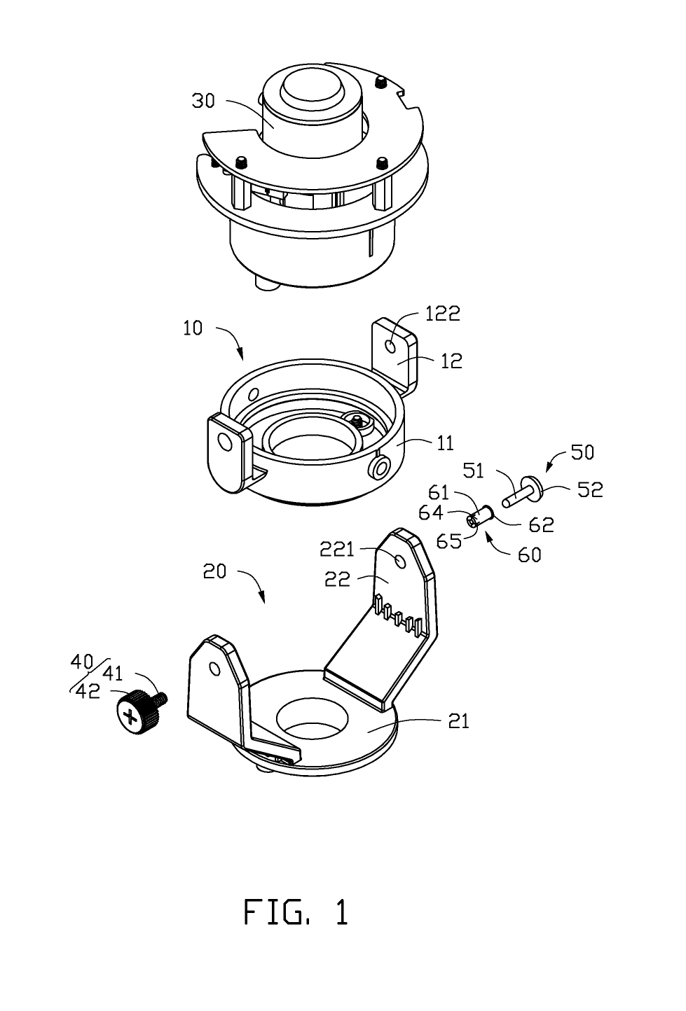

FIG. 1 shows an exemplary embodiment of a rotation mechanism for positioning a lens module 30. The rotation mechanism comprises a first bracket 10, a second bracket 20, a screw 40, a pin 50, and a connection member 60.

The first bracket 10 comprises a cylindrical base 11 and two opposite pivot arms 12 extending from a circumference of the base 11. Each pivot arm 12 defines a locking hole 122.

The second bracket 20 comprises a base plate 21 and two opposite pivot plates 22 extending from the base plate 21. Each pivot plate 22 defines a through hole 221.

The screw 40 comprises a threaded rod 41 and a screw cap 42 formed on an end of the threaded rod 41.

The pin 50 comprises a rod portion 51 and a head 52 formed on an end of the rod portion 51. The cross-section of the head 52 is larger than the cross-section of the rod portion 51.

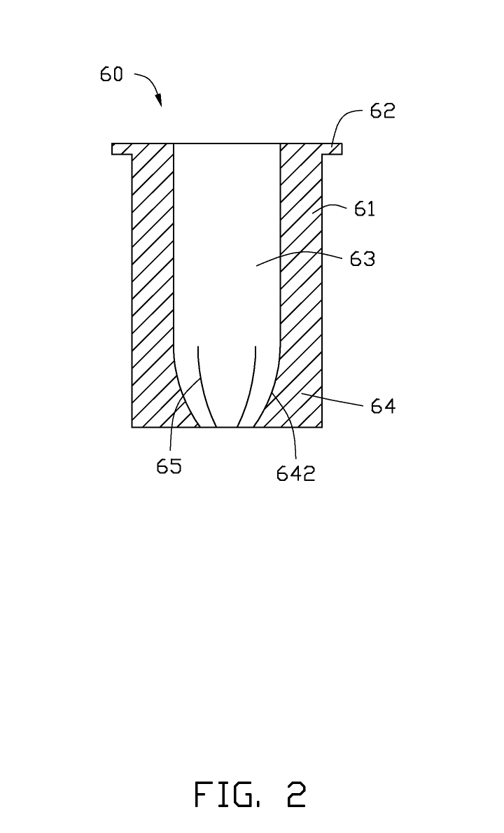

FIGS. 1 and 2 show the connection member 60 comprising a columnar main body 61, a stop tab 62 extending outward from a first end of the main body 61 and surrounding the first end of the main body 61, and a fastening portion 64 formed on a second end of the main body 61 opposite to the first end. The main body 61 axially defines a through hole 63 extending through the first and second ends of the main body 61. The through hole 63 becomes narrower in the fastening portion 64. The fastening portion 64 defines a plurality of slits 65 communicating with the through hole 63 and parallel to a lengthwise direction of the main body 61. The fastening portion 64 comprises an inner wall 642.

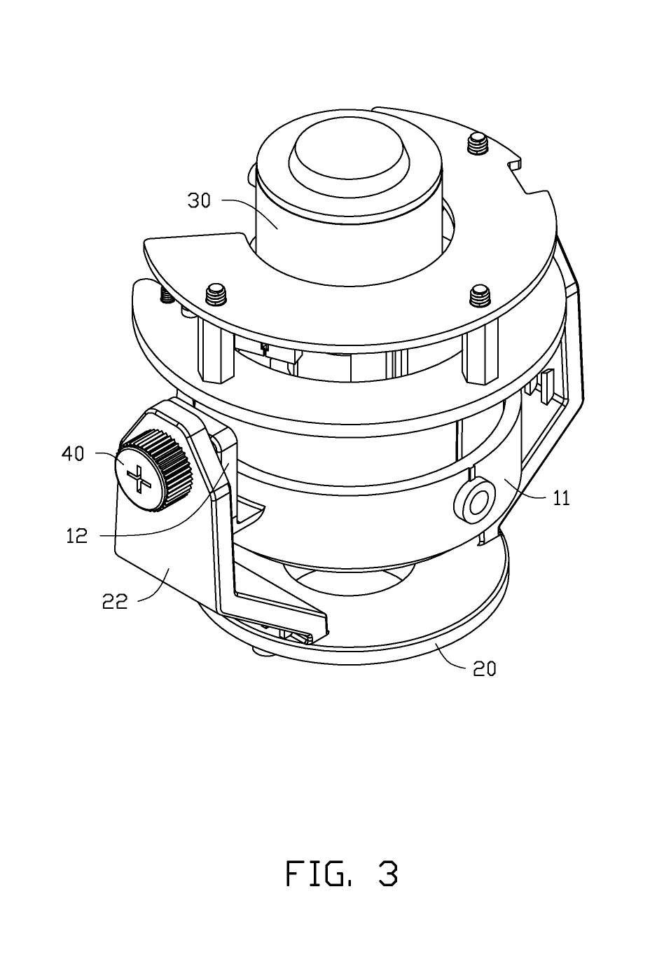

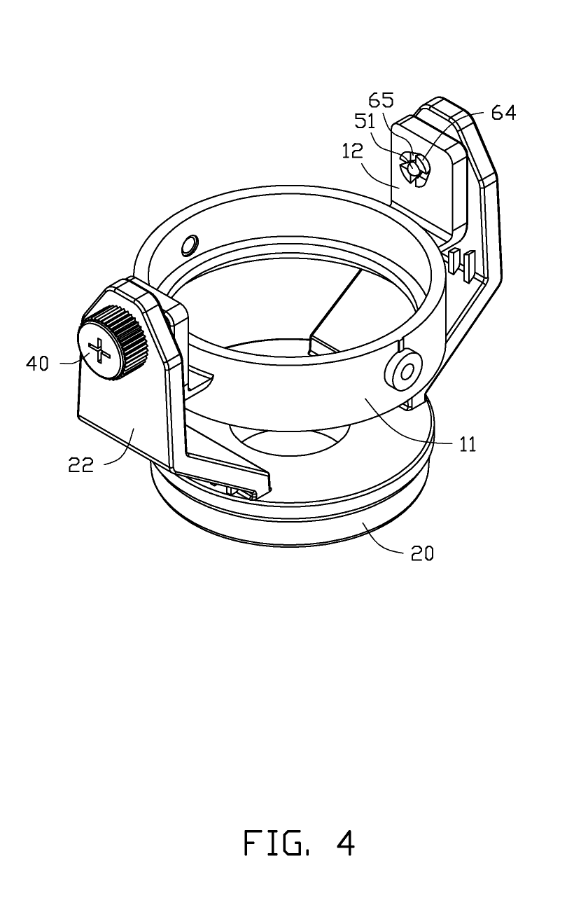

FIGS. 3 and 4 show that when assembled, the lens module 30 is mounted into the base 11 of the first bracket (not shown). The first bracket is placed between the pivot plates 22, and the locking holes align with the through holes. The fastening portion 64 of the connection member extends through one of the through holes and the corresponding locking hole. The stop tab abuts against an outer side surface of the corresponding pivot plate 22. The rod portion 51 of the pin faces the stop tab, and is extended into the through hole. The rod portion 51 enters the fastening portion 64 and abuts against the inner wall of the fastening portion 64, to make the fastening portion 64 expand to block an inner side surface of the corresponding pivot arm 12. The head 52 of the pin 50 abuts against the stop tab 62. The threaded rod 41 extends through the other through hole, and engages in the corresponding locking hole, the screw cap abuts against the corresponding pivot plate 22, to position the first bracket to the second bracket 20.

When the screw 40 is released, the first bracket 10 can be rotated to allow the lens module 30 to be adjusted to a proper angle. Then the screw 40 can engage in the corresponding locking hole again.

The connection member and the pin rotatably couple the first bracket 10 to the second bracket 20 first, and then the screw 40 positions the first bracket 10 to the second bracket 20. The first bracket 10 can be fastened to the second bracket 20 firmly.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A rotation mechanism, comprising:
a first bracket comprising a base for receiving a lens module, and two opposite pivot arms extending from the base;
a second bracket comprising two opposite pivot plates, the first bracket located between the pivot plates;
a connection member comprising a main body, a stop tab extending from a first end of the main body, and a fastening portion formed on a second end of the main body, the main body axially defining a through hole, the fastening portion defining a plurality of slits communicating with the through hole, the main body extending through one of the pivot plates and the corresponding pivot arm, and the stop tab abutting against an outer side surface of the corresponding pivot plate;
a pin extending into the through hole to make the fastening portion expand to be blocked an inner side surface of the corresponding pivot arm; and
a screw extending through the other pivot plate and engaging in the other pivot arm.

2. The rotation mechanism of claim 1, wherein the plurality of slits is parallel to a lengthwise direction of the main body.

3. The rotation mechanism of claim 1, wherein the pin comprises a rod portion configured to extend into the through hole and a head formed on an end of the rod portion configured to abut against the stop tab of the connection member.

4. The rotation mechanism of claim 1, wherein the through hole becomes narrower in the fastening portion, and the pin abuts against an inner wall of the fastening portion to make the fastening portion expand.

5. The rotation mechanism of claim 1, wherein the stop tab extends outward from the first end of the main body and surrounds the first end of the main body.
